(19) United States
(12) Patent Application Publication
(10) Pub. No.: US 2004/0031761 A1
(43) Pub. Date: Feb. 19, 2004

(54) Device for electrolytic water disinfection without cathodic hydrogen evolution

(76) Inventors: Maja Wunsche, Berlin (DE); Alexander Kraft, Berlin (DE); Wolfgang Kirstein, Ludwigsfelde (DE); Manfred Blaschke, Berlin (DE); Helmut Petzer, Schildow (DE)

Correspondence Address: Brinks Hofer Gilson & Lione, Suite 1600, One Indiana Square, Indianapolis, IN, 46204, US

(21) Appl. No.: 10/381,756

(22) PCT Filed: Sep. 27, 2001
(86) PCT No.: PCT/EP01/11287

(30) Foreign Application Priority Data
Sep. 29, 2000 (DE) 100 48 299.6

(51) Int. Cl. B03C 1/00

(52) U.S. Cl. 210/748

(57) ABSTRACT

The invention relates to a novel device for electrolytic disinfection of drinking water, service water and waste water using anodically generated disinfectants. The cathodic formation of hydrogen is prevented by using gas diffusion electrodes as the cathode. Atmospheric oxygen is reduced to hydroxyl ions and/or hydrogen peroxide at the gas diffusion electrodes. A permanent anode can be positioned between two gas diffusion electrodes. The latter then function alternately as a cathode or a second anode. This polarity change enables the removal of the deposits containing metal ions that form during the cathodic reaction from the gas diffusion electrodes. The substances with the disinfecting effect are produced through the use of different electrode materials for the anode and the diffusion electrode either at both anodes or at the anode and cathode.

### DESCRIPTION

The invention relates to a device for electrolytic disinfection of drinking water, service water and waste water, using anodically generated disinfectants, wherein the undesired formation of hydrogen during the partial cathodic reaction is avoided.

Electrolytic water disinfection is an efficient and cost-effective method of disinfecting water. It can be defined roughly as follows, killing of micro-organisms in water to be treated, through the action of an electric current introduced into the water via electrodes. This electric current can lead both to the anodic generation of disinfectant substances from the water itself or from substances dissolved in it, and also to the direct killing of micro-organisms on contact with the electrodes and by shifts of the pH value in the vicinity of the electrodes.

The most important anodic reactions with which oxidising and disinfectant substances (e.g. hypochlorous acid HClO, peroxodisulfate S₂O₈²⁻, hydrogen peroxide H₂O₂, ozone O₃, permanganate MnO₄⁻) are generated from the water and its natural components, are the following:

2Cl⁻→Cl₂+2e⁻ (1a)

Cl₂+H₂O→HClO+HCl (1b)

2HSO₄⁻→S₂O₈²⁻+2H⁺+2e⁻ (2)

2H₂O→H₂O₂+2H⁺+2e⁻ (3)

3H₂O→O₈+6e⁻+6H⁺ (4)

Mn²⁺+4H₂O→MnO₄⁻+8H⁺+5e⁻ (5)

Generally, the hypochlorous acid (also described as so-called “free chlorine”) generated from the natural chloride content of the water according to equations 1a and 1b is by far the most important disinfectant of electrolytic water disinfection.

In addition to the reactions according to equations 1 to 5, oxygen evolution takes place as the anodic reaction, generally in great excess.

2H₂O→O₂+4H⁺+4e⁻ (6)

Besides the designations electrochemical or electrolytic water disinfection, other names are also often used, such as the somewhat misleading designations Anodic Oxidation or Weak-current Electrolysis.

A large number of devices for electrolytic water disinfection are known according to prior art (e.g. the publications DE3430616, EP515628, U.S. Pat. No. 5,807,473, EP711730, DE19534736, WO97/11908, DE19633342), but all of these have the decided disadvantage that during the electrolytic treatment of the water to be disinfected, hydrogen is produced at the cathodes in accordance with

2H₂O+2e⁻→H₂+2OH⁻ (7)

If the cathode reaction runs 100% as hydrogen evolution, roughly 0.4 l hydrogen are produced per Ah. In particular, in cooperation with oxygen produced during electrolysis at the anode in accordance with equation (6), the hydrogen can lead to the formation of a dangerous explosive oxyhydrogen gas mixture.

Furthermore, the accumulation of quite large amounts of hydrogen in pipeline systems in which water circulates can lead to disruption of water circulation. Hydrogen can penetrate into many metals and lead to specific forms of corrosion or embrittlement. For these reasons, the undesired formation of hydrogen has been up to the present day the most important cause for the method of electrolytic water disinfection not being able to become established on the market to a greater extent.

In DE19631842 is proposed the use of an oxygen-consuming cathode for the electrolytic treatment of drinking water and service water. At an oxygen-consuming cathode, oxygen can be reduced to hydrogen peroxide and hydroxyl ions according to equation (8), or only to hydroxyl ions according to equation (9).

O₂+2H₂O+2e⁻→H₂O₂+2OH⁻ (8)

O₂+2H₂O+4e⁻→4OH⁻ (9)

The use of such an electrode does indeed lead to the avoidance of cathodic hydrogen formation, if sufficient oxygen is available to be able to let the reaction of the oxygen reduction run its desired course. Moreover, even during the cathodic reaction, a disinfectant is formed, and this possibly improves the efficiency of the method. However, hydrogen peroxide has a lower oxidation potential by comparison with most of the substances formed at the anode according to equations 1 to 5, and therefore often only leads to unsatisfactory results. Also, hydrogen peroxide is not permitted in every case as a disinfectant. Thus, for example, in Germany it must not be used for disinfecting drinking water. What is also disadvantageous is that the hydrogen peroxide formed at the oxygen-consuming cathode can react with the anodically formed free chlorine according to

H₂O₂+HClO→H₂O+HCl+O₂ (10)

and this can lead to the elimination of the most important disinfectant formed anodically, free chlorine. A further disadvantage of oxygen-consuming cathodes of the type mentioned in DE19631842 is the fact that only the oxygen dissolved in the water can be used for the reactions as per equations 8 and 9. The solubility of oxygen in water is very low, however, and at atmospheric pressure is typically at the most 8 to 10 mg/l. Even if pure oxygen from a gas cylinder or the anodically formed oxygen is used to saturate the water with oxygen, only values below 25 mg/l are obtained. Therefore, the possible reaction speeds and consequently the applicable current densities are very low, if one does not wish to accept the cathodic formation of hydrogen, For this reason, electrolytic devices for water disinfection using oxygen-consuming cathodes according to DE19632842 have also not been able to become established to a greater extent in practice.

The object underlying the invention, therefore, is to quote an electrochemical device which is substantially improved by comparison with the prior art and with which electrolytic water disinfection using anodically generated disinfectants and avoiding cathodic hydrogen evolution can be carried out rapidly, reliably and in a cost-effective manner.

According to the invention, the object is accomplished in that as the cathodes are used oxygen-consuming cathodes in the form of gas-diffusion electrodes, at which oxygen, preferably atmospheric oxygen, is reduced to hydroxyl ions and/or hydrogen peroxide. In these gas-diffusion electrodes, oxygen diffuses from the ambient air through a water-impermeable but oxygen-permeable membrane into a porous electrode material.

In this porous electrode material, which is also penetrated by the electrolyte, i.e. the water to be disinfected, the oxygen is then reduced to hydroxyl ions or hydrogen peroxide and hydroxyl ions. In both cases, hydroxyl ions are produced which leads to an alkaline pH value in the immediate vicinity of the gas-diffusion electrode connected as the cathode.

In an embodiment of the invention, the gas-diffusion electrode comprises a water-impermeable but oxygen-permeable Teflon film, a carbon layer acting as the porous electrode and a metal wire netting or expanded metal which serves for supplying current and for the mechanical stabilization of the electrode.

According to a further feature of the invention, the metal wire netting or expanded metal consists of titanium or some other valve metal since these have a particularly high electrochemical stability.

In various applications of electrolytic water disinfection, the cathodic formation of hydrogen peroxide can be used very sensibly to supplement the anodic formation of disinfectants. In applications in which the formation of hydrogen peroxide is not desired, such as in the case of disinfecting drinking water for example, the cathodic formation of hydrogen peroxide at the oxygen-consuming cathode can be avoided, according to an embodiment of the invention, in that the carbon layer is coated with platinum. In a further embodiment of the invention, instead of platinum the oxide of an element from the group of platinum metals, preferably iridium oxide or ruthenium oxide can be applied for this purpose to the carbon layer or/and to the metal wire netting or expanded metal.

If water at relatively high pressures, such as are usual in the domestic water supply for example, is to be treated by electrolytic water disinfection, the electrodes used must also permanently withstand these pressures. According to the invention, the gas-diffusion electrode must be additionally supported from outside in order also to be able to treat electrolytically water at quite high pressures.

In an embodiment of the invention, titanium electrodes coated with mixed oxides are used as the anode. Titanium electrodes coated with mixed oxides are particularly suitable when hypochlorite and hypochlorous acid are to be generated as effectively as possible from the natural chloride content of the water.

In a further embodiment of the invention, diamond electrodes doped with boron are used as the anode. These boron-doped diamond electrodes are especially suitable when the natural chloride content of the water to be disinfected is very low and other disinfectant substances, such as ozone, peroxodisulfate and in particular OH radicals, for example, are to be generated as effectively as possible.

In the treatment of water which contains constituents which form poorly soluble precipitates and deposits, the unavoidable formation of hydroxyl ions during oxygen reduction leads to deposits on the cathode. An example is the deposition of lime on the cathode during the electrochemical disinfection of water containing hardening constituents. The time is usually removed by a periodic change of polarity. It is known, however, that the service life of titanium electrodes coated with mixed oxides is severely reduced by a periodic change of polarity. Moreover, a change of polarity when a gas-diffusion electrode and a titanium electrode coated with mixed oxides are being used would again lead to the production of the undesired hydrogen gas occurring when the titanium electrode coated with mixed oxides is connected as the cathode. In an embodiment of the invention, therefore, a unit of the device for electrolytic water disinfection avoiding cathodic hydrogen evolution comprises an anode which is positioned between two gas-diffusion electrodes, only one of the gas-diffusion electrodes being connected as the cathode, but the second being connected as an auxiliary anode.

According to the invention, a periodic change of polarity takes place between the two gas-diffusion electrodes in order to dissolve again anodically deposits formed on the cathode. The anode located between the gas-diffusion electrodes operates by contrast as a permanent anode.

In an embodiment of the invention, a modular device which can be adapted to a particular problem is produced in that a plurality of units comprising respectively two gas-diffusion electrodes and an anode located between same are connected in parallel or in series behind one another.

### EMBODIMENTS

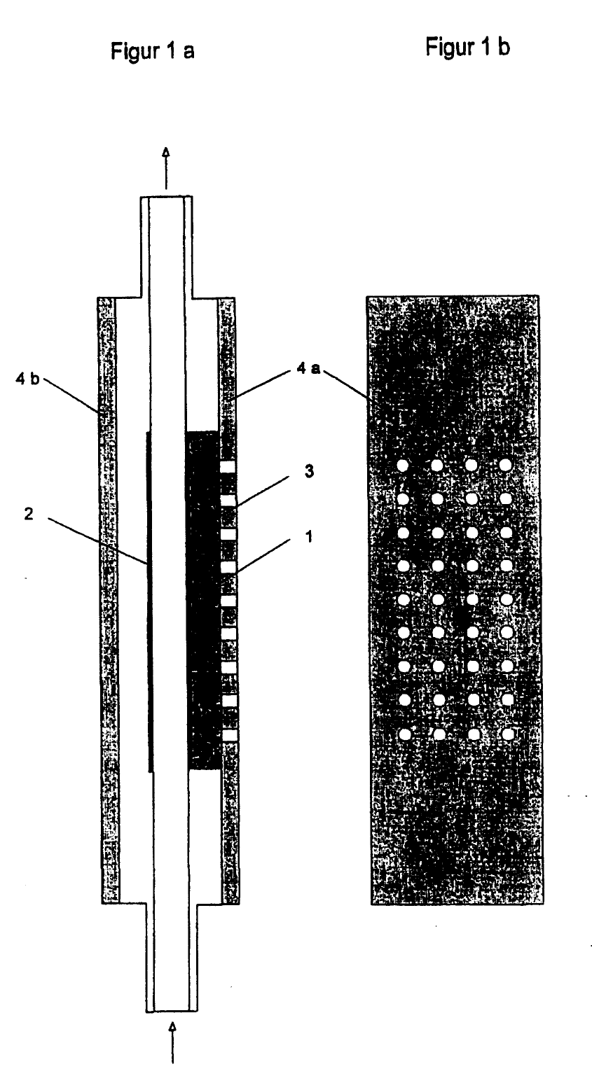

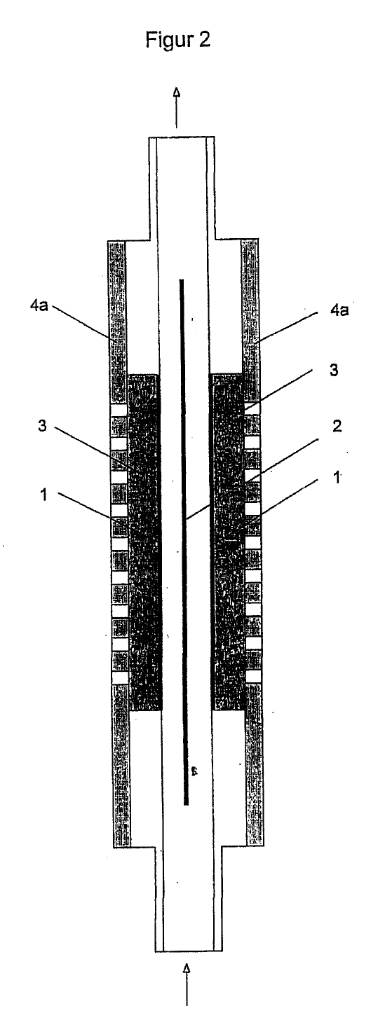

In FIGS. 1 and 2 are shown diagrammatically possible embodiments for the construction of a device for electrolytic water disinfection using anodically generated disinfectants without cathodic hydrogen evolution.

1. FIG. 1a is a sectional view of a complete electrolytic cell. The cell follows the principle of a frame-type pressure cell. Between two pressure plates (4a and 4b) are fixed an anode (2) and a gas-diffusion electrode as the cathode (1). The pressure plate 4b (FIG. 1b) is here perforated over the area of the gas-diffusion electrode. The gas-diffusion electrode is mechanically stabilised over the entire surface by a porous support plate (3). A porous filter material (40% porosity) of pure polyethylene was used as the support material. Unrestricted access of air to the gas-diffusion electrode is possible. Water flows through the cell from top to bottom.

a) For the electrolytic generation of free chlorine as a disinfectant, a titanium electrode coated with iridium, produced by the company Metakem GmbH Usingen, is used as the anode. The gas-diffusion electrode comprises a metal wire netting or expanded metal (e.g. Ni, Fe, Ti) and a graphite layer with catalysts (e.g. Mn, Pt) which prevent the production of hydrogen peroxide.

Tests were carried out with various gas-diffusion electrodes and varying the chloride content of the water and the current density. When the gas-diffusion electrode MOC (with PTFE on silver-plated nickel netting; from the company Gaskatel GmbH Kassel) is used, 33 mg/Ah free chlorine can be obtained with a chloride content of the water of 60 mg/l with j=18 mA/cm² (further values in Tab. 1).

| Chloride | Production of | free chlorine |
|---|---|---|
| concentration | Current density | Current density |
| in the water | j = 18 mA/cm² | j = 36 mA/cm² |
| 60 mg/l | 33 mg/Ah | 35 mg/Ah |
| 240 mg/l | 160 mg/Ah | 250 mg/Ah |

The pH value and the electrical conductivity of the treated water remain unaltered.

b) For the anodic generation of hydrogen peroxide as a disinfectant, boron-doped diamond electrodes (Fraunhofer Institut Schicht- and Oberflächentechnik Braunschweig) are used as the anode. As the gas-diffusion electrode are used the kinds which have hydrogen peroxide-active types of graphite. Various concentrations of hydrogen peroxide can be obtained via the selection of the types of graphite and the current density.

| | Description of | Hydrogen peroxide |
|---|---|---|
| | the types of | production |
| Pos. | graphite | (mg/Ah) |
| 1 | Graphite KS 75 | 112 |
| 2 | Graphite MCITB | 25 |
| 3 | Graphite PC 006 | 205 |

2. FIG. 2 is a sectional view of a cell for electrochemical water disinfection and treatment, in which a periodic change of polarity is possible between the gas-diffusion electrodes. The cell is based on the principle of a frame-type pressure cell. Between two gas-diffusion electrodes (1), which are stabilised over the entire surface of the electrode by means of a porous support plate (3), is located in the centre as an anode (2) a titanium electrode coated with iridium oxide. The anode operates as a permanent anode. The gas-diffusion electrode contains as the metal wire netting an expanded titanium metal coated with iridium mixed oxide. Between the two gas-diffusion electrodes a periodic change of polarity takes place, such that one gas-diffusion electrode is connected as the cathode and the other as an auxiliary anode.

When the cell is used in electrolytic water disinfection, the lime deposited at the gas-diffusion electrode operating cathodically is dissolved again at the gas-diffusion electrode connected as an auxiliary anode.

1. Device for electrolytic water disinfection by anodically generated disinfectants avoiding cathodic hydrogen evolution, characterised in that as the cathode is used an oxygen-consuming cathode in the form of a gas-diffusion electrode, which can be brought into contact with oxygen or with a gas containing oxygen.

2. Device according to claim 1, characterised in that the gas-diffusion electrode is partially in contact with the external air and has in the contact area a membrane which is permeable by oxygen and impermeable by water.

3. Device according to claim 2, characterized in that the membrane consists of Teflon.

4. Device according to one of claims 1 to 3, characterised in that the gas-diffusion electrode has a porous carbon layer.

5. Device according to claim 4, characterised in that the carbon layer is covered with a metal wire netting or an expanded metal.

6. Device according to claim 5, characterised in that the metal wire netting consists of titanium or some other valve metal.

7. Device according to one of claims 4 to 6, characterised in that, in order to prevent the formation of hydrogen peroxide, the carbon layer and/or the metal wire netting or expanded metal are coated with an oxide of an element from the group of platinum metals, preferably iridium oxide or ruthenium oxide.

8. Device according to one of claims 1 to 7, characterised in that the gas-diffusion electrode is supported mechanically on the side remote from the water.

9. Device according to claim 8, characterised in that the support for the gas-diffusion electrodes consists of a porous plastics material or metal.

10. Device according to one of claims 1 to 9, characterised in that the anode is a titanium electrode coated with mixed oxides.

11. Device according to one of claims 1 to 9, characterised in that the anode is a diamond electrode doped with boron.

12. Device according to one of claims 1 to 11, characterized in that that respectively one anode is positioned between 2 gas-diffusion electrodes which are connected alternately as the cathode and as the auxiliary anode.

13. Device according to claim 12, characterized in that a plurality of units cormprising respectively two gas-diffusion electrodes and an anode located between same are connected in parallel or in series behind one another.
